(19) United States
(12) Patent Application Publication
(10) Pub. No.: US 2023/0416497 A1
(43) Pub. Date: Dec. 28, 2023

(54) USE OF SURFACTANT FORMULATIONS COMPRISING LONG-CHAIN ALCOHOLS IN AQUEOUS POLYURETHANE DISPERSIONS

(71) Applicant: Evonik Operations GmbH, Essen (DE)

(72) Inventors: Michael Klostermann, Essen (DE); Kai-Oliver Feldmann, Essen (DE); Marvin Jansen, Essen (DE); Sina Arnold, Bottrop (DE)

(73) Assignee: Evonik Operations GmbH, Essen (DE)

(21) Appl. No.: 18/458,587

(22) Filed: Aug. 30, 2023

Related U.S. Application Data
(63) Continuation of application No. 17/333,559, filed on May 28, 2021.

(30) Foreign Application Priority Data
Jun. 24, 2020 (EP) 20181882.0

(51) Int. Cl. C08K 5/05; C09D 7/60; C08J 9/00; C09D 175/04; C09K 23/14; C09K 23/34; C09K 23/38; C09K 23/08

(52) U.S. Cl. CPC C08K 5/05; C09D 7/60; C08J 9/0023; C09D 175/04; C09K 23/14; C09K 23/34; C09K 23/38; C09K 23/08; C08J 2375/04

(57) ABSTRACT

The use of surfactant formulations comprising long-chain alcohols as additives in aqueous polymer dispersions for production of porous polymer coatings, preferably for production of porous polyurethane coatings, is described.

The present invention is in the field of plastics coatings and imitation leathers.

It relates more particularly to the production of porous polymer coatings, preferably porous polyurethane coatings, using surfactant formulations comprising long-chain alcohols as additives.

Textiles coated with plastics, for example imitation leathers, generally consist of a textile carrier onto which is laminated a porous polymer layer which has in turn been coated with a top layer or a topcoat.

The porous polymer layer in this context preferably has pores in the micrometre range and is air-permeable and hence breathable, i.e. permeable to water vapor, but water-resistant. The porous polymer layer often comprises porous polyurethane. For environmentally friendly production of PU-based imitation leather, a method based on aqueous polyurethane dispersions, called PUDs, has recently been developed. These generally consist of polyurethane microparticles dispersed in water; the solids content is usually in the range of 30-60% by weight. For production of a porous polyurethane layer, these PUDs are mechanically foamed, coated onto a carrier (layer thicknesses typically between 300-2000 μm) and then dried at elevated temperature. During this drying step, the water present in the PUD system evaporates, which results in formation of a film of the polyurethane particles. In order to further increase the mechanical strength of the film, it is additionally possible to add hydrophilic (poly)isocyanates to the PUD system during the production process, and these can react with free OH radicals present on the surface of the polyurethane particles during the drying step, thus leading to additional crosslinking of the polyurethane film.

Both the mechanical and the tactile properties of PUD coatings thus produced are determined to a crucial degree by the cell structure of the porous polyurethane film. In addition, the cell structure of the porous polyurethane film affects the air permeability and breathability of the material. Particularly good properties can be achieved here with very fine, homogeneously distributed cells. A customary way of influencing the cell structure during the above-described production process is to add foam stabilizers to the PUD system before or during the mechanical foaming. A first effect of appropriate stabilizers is that sufficient amounts of air can be beaten into the PUD system during the foaming operation. Secondly, the foam stabilizers have a direct effect on the morphology of the air bubbles produced. The stability of the air bubbles is also influenced to a crucial degree by the type of stabilizer. This is important especially during the drying of foamed PUD coatings, since it is possible in this way to prevent drying defects such as cell coarsening or drying cracks.

Various foam stabilizers have already been used in the past in the above-described PUD process. Document US 2015/0284902 A1 or US 2006 0079635 A1, for example, describes the use of ammonium stearate-based foam stabilizers. However, the use of corresponding ammonium stearate-based stabilizers is associated with a number of drawbacks. A significant drawback here is that ammonium stearate has a very high migration capacity in the finished imitation leather. The effect of this is that surfactant molecules accumulate at the surface of the imitation leather with time, which can result in white discoloration at the leather surface. Furthermore, this surfactant migration can result in a greasy film that is perceived as unpleasant on the surface of the imitation leather, especially when corresponding materials come into contact with water.

A further drawback of ammonium stearate is that it forms insoluble lime soaps on contact with hard water. In the case of contact of imitation leather produced on the basis of ammonium stearate with hard water, white efflorescence can thus arise at the imitation leather surface, which is undesirable especially in the case of dark-colored leather.

Yet another drawback of ammonium stearate-based foam stabilizers is that they do permit efficient foaming of aqueous polyurethane dispersions, but often lead to quite a coarse and irregular foam structure. This can have an adverse effect on the optical and tactile properties of the finished imitation leather.

Yet another drawback of ammonium stearate is that the PUD foams produced often have inadequate stability, which can lead to drawbacks in the processing thereof, especially in the drying of the PUD foams at elevated temperatures. A consequence of this is, for example, that corresponding foams have to be dried relatively gently and slowly, which in turn leads to longer process times in imitation leather production.

As an alternative to ammonium stearate-based foam stabilizers, polyol esters and polyol ethers were identified in the past as effective foam additives for aqueous polyurethane dispersions. These structures are described, for example, in documents EP 3487945 A1 and WO2019042696A1. Compared to ammonium stearate, polyol esters and polyol ethers have the major advantage that they migrate only slightly, if at all, in the finished imitation leather and hence do not lead to unwanted surface discoloration. Moreover, polyol esters and polyol ethers are not sensitive to hard water.

A further advantage of polyol esters and polyol ethers over ammonium stearate-based foam stabilizers is additionally that they often lead to a distinctly finer and more homogeneous foam structure, which has advantageous effects on the properties of imitation leather materials produced with these substances. Polyol esters and polyol ethers often also lead to much more stable PUD foams, which in turn brings process-related advantages in imitation leather production.

In spite of these advantages, polyol esters and polyol ethers are also not entirely free of drawbacks. A potential drawback is that the foam-stabilizing effect of these compound classes can be impaired under some circumstances by the presence of further cosurfactants present in the PUD system. Especially in the production of aqueous polyurethane dispersions, however, the use of cosurfactants is not unusual. Cosurfactants are used in this context for improved dispersion of polyurethane prepolymers in water and generally remain in the final product. During the mechanical foaming of aqueous polyurethane dispersions containing polyol esters or polyol ethers as foam additives, corresponding cosurfactants can have adverse effects on the foaming characteristics of the system under some circumstances. As a result, in some cases, it is often possible for only little air, if any at all, to be beaten into the system; the resultant foam structure is comparatively coarse and the leather quality is reduced. Cosurfactants can also have an adverse effect on the stability of the foams produced, which can result in foam ageing during the processing of the foamed PUD system, which in turn leads to faults and defects in the foam coatings produced.

A potential drawback is that PUD systems containing polyol esters or polyol ethers as foam additives often require very high shear energies for efficient foaming. This in turn can entail limitations and process-related drawbacks under some circumstances. It limits the selection of machinery utilized industrially for foam generation.

The problem addressed by the present invention was therefore that of providing additives for production of PUD-based foam systems and foam coatings that enable efficient foaming of PUD systems and do not have the drawbacks detailed in the art. It has been found that, surprisingly, surfactant formulations comprising long-chain alcohols enable the solution of the stated problem.

The present invention therefore provides for the use of surfactant formulations comprising long-chain alcohols as additives, preferably as foam additives, in aqueous polymer dispersions, preferably aqueous polyurethane dispersions, for production of porous polymer coatings, preferably for production of porous polyurethane coatings.

The inventive use of surfactant formulations comprising long-chain alcohols surprisingly has various advantages here. Since long-chain alcohols, used as sole additives in aqueous polymer dispersions, have negligible foam-stabilizing properties, if any, and can even have a defoaming effect, these advantages were all the more unexpected.

One advantage is that the inventive surfactant formulations comprising long-chain alcohols enable particularly efficient foaming of aqueous PUD systems. The foams thus produced are notable here for an exceptionally fine pore structure with particularly homogeneous cell distribution, which in turn has a very advantageous effect on the mechanical and tactile properties of the porous polymer coatings which are produced on the basis of these foams. In addition, it is possible in this way to improve the air permeability or breathability of the coating.

A further advantage is that the inventive surfactant formulations comprising long-chain alcohols, even at relatively low shear rates, enable efficient foaming of PUD systems, which leads to fewer limitations and broader processability during imitation leather production.

Yet another advantage is that the inventive surfactant formulations comprising long-chain alcohols enable the production of particularly stable foams. This firstly has an advantageous effect on their processability. Secondly, the elevated foam stability has the advantage that, during the drying of corresponding foams, drying defects such as cell coarsening or drying cracks can be avoided. Furthermore, the improved foam stability enables quicker drying of the foams, which offers processing advantages both from an environmental point of view, because it saves energy, and from an economic point of view.

Yet another advantage is that the efficacy of the inventive surfactant formulations comprising long-chain alcohols is barely impaired, if at all, by cosurfactants present in the PUD system. Thus, the surfactant formulations according to the invention, even in the case of cosurfactant-containing PUD systems, enable efficient foaming of the system, and the formation of fine and homogeneous foams that are simultaneously extremely stable.

Yet another advantage is that the inventive surfactant formulations comprising long-chain alcohols, in the finished imitation leather, have barely any migration capacity, if any, and thus do not lead to unwanted surface discoloration or efflorescence. Furthermore, the surfactant formulations according to the invention are barely sensitive to hard water, if at all.

The term “surfactant formulations” throughout the present invention encompasses formulations comprising at least one interface-active foam stabilizer (or interface-active foaming aid) and also at least one long-chain alcohol, and optionally further surfactants or interface-active substances (cosurfactants).

What is meant by “long-chain” in this context is that the alcohol has at least 12, preferably at least 14, carbon atoms, more preferably at least 16 carbon atoms. Preference is given here both to branched and linear alcohols. It should be made clear that the inventive use of surfactant formulations in aqueous polymer dispersions includes the options that foam stabilizer, long-chain alcohol and any further surfactants may be added to the aqueous polymer dispersion either in the form of a pre-formulated 1-component mixture or of separate components or in the form of multiple formulations containing the respective individual components, which respectively correspond to particularly preferred embodiments of the invention.

The term “cosurfactant” throughout the present invention encompasses additional surfactants that may be present in the polymer dispersion alongside the inventive surfactant formulations comprising long-chain alcohols. These especially include surfactants that are used during the production of the polymer dispersion. For example, polyurethane dispersions are often produced by synthesis of a PU prepolymer which, in a second step, is dispersed in water and then reacted with a chain extender. For improved dispersion of the prepolymer in water, it is possible here to use cosurfactants. In the context of the present invention, the cosurfactants are preferably anionic cosurfactants.

The invention is described further and by way of example hereinafter, without any intention that the invention be restricted to these illustrative embodiments. Where ranges, general formulae or compound classes are specified below, these are intended to include not only the corresponding ranges or groups of compounds which are explicitly mentioned but also all subranges and subgroups of compounds which can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless otherwise stated, percentages are in percent by weight. Where parameters that have been determined by measurement are given hereinbelow, the measurements have been carried out at a temperature of 25° C. and a pressure of 101 325 Pa, unless otherwise stated. Where chemical (empirical) formulae are used in the present invention, the specified indices can be not only absolute numbers but also average values. For polymeric compounds, the indices preferably represent average values. Structural and empirical formulae presented in the present invention are representative of all isomers that are possible by differing arrangement of the repeating units.

In the context of the present invention, it is preferable when the long-chain alcohol present in the surfactant formulations according to the invention conforms to the general formula (I)

R¹—OH Formula (I)

where R¹ is a monovalent aliphatic or aromatic, saturated or unsaturated, linear or branched hydrocarbyl radical having 12 to 40 carbon atoms, preferably 14 to 30 and more preferably 16 to 24 carbon atoms.

It is especially preferable here when the alcohols present in the surfactant formulations according to the invention are lauryl alcohol (1-dodecanol), myristyl alcohol (1-tetradecanol), cetyl alcohol (1-hexadecanol), margaryl alcohol (1-heptadecanol), stearyl alcohol (1-octadecanol), arachidyl alcohol (1-eicosanol), behenyl alcohol (1-docosanol), lignoceryl alcohol (1-tetracosanol), ceryl alcohol (1-hexacosanol), montanyl alcohol (1-octacosanol), melissyl alcohol (1-triacontanol), palmitoleyl alcohol (cis-9-hexadecen-1-ol), oleyl alcohol (cis-9-octadecen-1-ol), elaidyl alcohol (trans-9-octadecen-1-ol) and/or respective structural isomers of the same empirical formulae, and mixtures of these substances, particular preference being given to cetyl alcohol, stearyl alcohol and/or behenyl alcohol and to mixtures of these two substances.

Sources of the above-described long-chain alcohols may be vegetable or animal fats, oils or waxes. For example, it is possible to use: pork lard, beef tallow, goose fat, duck fat, chicken fat, horse fat, whale oil, fish oil, palm oil, olive oil, avocado oil, seed kernel oils, coconut oil, palm kernel oil, cocoa butter, cottonseed oil, pumpkinseed oil, maize kernel oil, sunflower oil, wheatgerm oil, grapeseed oil, sesame oil, linseed oil, soybean oil, peanut oil, lupin oil, rapeseed oil, mustard oil, castor oil, jatropha oil, walnut oil, jojoba oil, lecithin, for example based on soya, rapeseed or sunflowers, bone oil, neatsfoot oil, borage oil, lanolin, emu oil, deer tallow, marmot oil, mink oil, safflower oil, hemp oil, pumpkin oil, evening primrose oil, tall oil, and also carnauba wax, beeswax, candelilla wax, ouricury wax, sugarcane wax, retamo wax, caranday wax, raffia wax, esparto wax, alfalfa wax, bamboo wax, hemp wax, Douglas fir wax, cork wax, sisal wax, flax wax, cotton wax, dammar wax, tea wax, coffee wax, rice wax, oleander wax or wool wax.

It is further preferable when the alcohols present in the surfactant formulations according to the invention are long-chain branched primary or secondary alcohols. Preference is given here especially to Guerbet alcohols, i.e. branched alcohols formed by Guerbet condensation, and to branched secondary alcohols formed by paraffin oxidation by the Bashkirov method.

In the context of the present invention, it is preferable when the interface-active foam stabilizers (or interface-active foaming aids) used in combination with long-chain alcohols are selected from the group of the amphoteric surfactants or betaines, e.g. amidopropyl betaines, amphoacetates, the anionic surfactants, e.g. the alkyl or alkylaryl sulfosuccinates, the sulfosuccinamates, the sulfates, the sulfonates, the phosphates and the citrates, the carboxylic salts, the nonionic surfactants, e.g. the polyol ethers, polyol esters, and mixtures of these substances, particular preference being given to polyol ethers, polyol esters, alkyl phosphates and alkyl citrates, and mixtures of these substances.

If the foam stabilizers used in combination with long-chain alcohols are polyol ethers, preference is given here especially to polyglycerol ethers, sorbitan ethers and mixtures of these substances, particular preference being given to polyglycerol ethers. In this connection, preference is given especially to polyglycerol ethers having an average of at least 2, preferably at least 3, polyglycerol units. Even more preferred in this connection are polyglycerol hexadecyl ether, polyglycerol octadecyl ether, polyglycerol hydroxyhexadecyl ether, especially polyglycerol 1-hydroxyhexadecyl ether, polyglycerol 2-hydroxyhexadecyl ether and/or polyglycerol hydroxyoctadecyl ether, especially polyglycerol 1-hydroxyoctadecyl ether and/or polyglycerol 2-hydroxyoctadecyl ether, and mixtures of these substances. In the case of the polyol ethers that are preferred in the context of the present invention, reference is also made to document WO2019042696A1 in full.

If the foam stabilizers used in combination with long-chain alcohols are polyol esters, preference is given here especially to polyglycerol esters, sorbitan esters and mixtures of these substances, particular preference being given to polyglycerol esters. In this connection, preference is given especially to polyglycerol esters having an average of at least 2, preferably at least 3, polyglycerol units. Even more preferred in this connection are polyglycerol palmitate and polyglycerol stearate, and mixtures of these substances. In the case of the polyol ether esters that are preferred in the context of the present invention, reference is also made to document EP 3487945 A1 in full.

If the foam stabilizers used in combination with long-chain alcohols are alkyl sulfosuccinamates, preference is given here especially to hexadecyl sulfosuccinamates, dihexadecyl sulfosuccinamates, octadecyl sulfosuccinamates, dioctadecyl sulfosuccinamates and mixtures of these substances.

If the foam stabilizers used in combination with long-chain alcohols are alkyl phosphates, preference is given here especially to phosphoric esters of long-chain alcohols having at least 12, preferably having at least 14, even more preferably having 16, carbon atoms. The degree of esterification of these phosphoric esters is preferably in the range of 1-2.5, preferably of 1.3-2.4, more preferably of 1.4-2.3, even more preferably of 1.5-2, where the degree of esterification is defined as the molar ratio of alcohol to phosphorus atoms. In this connection, very particular preference is given to hexadecyl phosphate, octadecyl phosphate and mixtures of these substances.

If the foam stabilizers used in combination with long-chain alcohols are alkyl citrates, preference is given here especially to citric esters of long-chain alcohols having at least 12, preferably having at least 14, even more preferably having 16, carbon atoms. The degree of esterification of these citric esters is preferably in the range of 1-2.6, preferably of 1.3-2.4, more preferably of 1.4-2.3, even more preferably of 1.5-2.2, where the degree of esterification is defined as the molar ratio of alcohol to citric acid unit. In this connection, very particular preference is given to hexadecyl citrate, octadecyl citrate and mixtures of these substances.

In the context of the present invention, it is preferable when the concentration of long-chain alcohol according to the invention in the surfactant formulations according to the invention is in the range from 0.1% to 60% by weight, preferably between 0.5% and 50% by weight, more preferably between 1% and 40% by weight, even more preferably between 2% and 30% by weight, based on the overall mixture of foam stabilizer and long-chain alcohol.

As already discussed, the present invention envisages the use of surfactant formulations comprising long-chain alcohols as described above as additives in aqueous polymer dispersions, preferably in aqueous polyurethane dispersions. The polymer dispersions here are preferably selected from the group of aqueous polystyrene dispersions, polybutadiene dispersions, poly(meth)acrylate dispersions, polyvinyl ester dispersions and polyurethane dispersions. The solids content of these dispersions is preferably in the range of 20-70% by weight, more preferably in the range of 25-65% by weight. Particular preference is given in accordance with the invention to the use of surfactant formulations comprising long-chain alcohols as additives in aqueous polyurethane dispersions. Especially preferable here are polyurethane dispersions based on polyester polyols, polyesteramide polyols, polycarbonate polyols, polyacetal polyols and polyether polyols.

When surfactant formulations comprising long-chain alcohols are used in aqueous polymer dispersions, it is preferable when the final concentration of foam stabilizer including long-chain alcohol in the aqueous polymer dispersion is in the range of 0.2-20% by weight, more preferably in the range of 0.4-15% by weight, especially preferably in the range of 0.5-10% by weight.

Preference is given to using the inventive surfactant formulations comprising long-chain alcohols in aqueous polymer dispersions as foaming aids or foam stabilizers for foaming of dispersions. In addition, however, they can also be used as drying aids, levelling additives, wetting agents and rheology additives.

As well as the inventive surfactant formulations comprising long-chain alcohols, the aqueous polymer dispersions may also comprise further additions/formulation components, for example color pigments, fillers, matting agents, stabilizers such as hydrolysis or UV stabilizers, antioxidants, bactericides, absorbers, crosslinkers, levelling additives, thickeners and further cosurfactants.

It is made clear that the use of surfactant formulations comprising long-chain alcohols as additives in aqueous polymer dispersions includes the possibility of addition of foam stabilizer, long-chain alcohol and optionally further surfactants (cosurfactant) to the aqueous polymer dispersion either as a pre-formulated mixture or as separate components, or in the form of multiple formulations containing the respective individual components. It is additionally possible here to blend all components or individual components in a solvent beforehand. Preferred solvents in this connection are selected from water, propylene glycol, dipropylene glycol, polypropylene glycol, butyldiglycol, butyltriglycol, ethylene glycol, diethylene glycol, polyethylene glycol, polyalkylene glycols based on EO, PO, BO and/or SO, alcohol alkoxylates based on EO, PO, BO and/or SO, and mixtures of these substances, very particular preference being given to aqueous dilutions or blends. It is very particularly preferable in this connection when foam stabilizer, long-chain alcohol and optionally further surfactants are blended to form an aqueous 1-component formulation. It is especially preferable when these formulations contain a total of between 10% and 80% by weight, more preferably between 15% and 70% by weight, even more preferably between 20% and 60% by weight, of foam stabilizer and long-chain alcohol.

In addition, in the case of aqueous 1-component formulations composed of foam stabilizer, long-chain alcohol and optionally further surfactants, it may be advantageous when the formulation properties (viscosity, homogeneity etc.) of the formulation are improved by adding hydrotropic compounds. Hydrotropic compounds here are water-soluble organic compounds consisting of a hydrophilic part and a hydrophobic part, but are too low in molecular weight to have surfactant properties. They lead to an improvement in the solubility or in the solubility properties of organic, especially hydrophobic organic, substances in aqueous formulations. The term “hydrotropic compounds” is known to those skilled in the art. Preferred “hydrotropic compounds” in the context of the present invention are alkali metal and ammonium toluenesulfonates, alkali metal and ammonium xylenesulfonates, alkali metal and ammonium naphthalenesulfonates, alkali metal and ammonium cumenesulfonates, and phenol alkoxylates, especially phenol ethoxylates, having up to 6 alkoxylate units.

As already described, the inventive surfactant formulations comprising long-chain alcohols may optionally comprise further surfactants (i.e. cosurfactants). These may be used, for example, for improved system compatibility or, in the case of pre-formulated 1-component formulations, for improved formulation properties. Cosurfactants that are preferred in accordance with the invention in this context are fatty acid amides, ethylene oxide-propylene oxide block copolymers, amine oxides, quaternary ammonium surfactants, amphoacetates, ammonium and/or alkali metal salts of fatty acids, and mixtures of these substances. In addition, the further surfactants may comprise silicone-based surfactants, for example trisiloxane surfactants or polyether siloxanes. In the case of ammonium and/or alkali metal salts of fatty acids, it is preferable when they contain less than 25% by weight of stearate salts, and are especially free of stearate salts.

If the surfactant formulations according to the invention, as well as foam stabilizer and long-chain alcohol, also comprise further surfactants (cosurfactants) as described above, it is especially preferred when these combinations include between 1% and 50% by weight, preferably between 2% and 50% by weight, more preferably between 3% and 40% by weight, even more preferably between 5% and 30% by weight, of additional surfactant, based on the overall composition composed of foam stabilizer, long-chain alcohol and further surfactants.

Since, as described above, the inventive use of surfactant formulations comprising long-chain alcohols leads to a distinct improvement in porous polymer coatings produced from aqueous polymer dispersions, the present invention likewise provides aqueous polymer dispersions comprising the surfactant formulations according to the invention, as described in detail above.

The present invention still further provides porous polymer layers which have been produced from aqueous polymer dispersions, obtained with the inventive use of surfactant formulations comprising long-chain alcohols, as described in detail above.

Preferably, the porous polymer coatings according to the invention can be produced by a process comprising the steps of
a) providing a mixture comprising at least one aqueous polymer dispersion, at least one of the surfactant formulations according to the invention, and optionally further formulation components,
b) foaming the mixture to give a foam,
c) optionally adding at least one thickener to adjust the viscosity of the wet foam,
d) applying a coating of the foamed polymer dispersion to a suitable carrier,
e) drying/curing the coating.

The porous polymer coatings have pores preferably in the micrometre range, preferably with an average cell size of less than 350 μm, more preferably less than 200 μm, especially preferably less than 150 μm, very especially preferably less than 100 μm. The average cell size can be determined preferably by microscope, preferably by electron microscopy. For this purpose, a cross section of the porous polymer coating is viewed by means of a microscope with a sufficient magnification and the size of at least 25 cells is determined. The average cell size then results as the arithmetic average of the cells or cell sizes viewed.

With a view to preferred configurations, especially with a view to the surfactant formulations and polymer dispersions that are usable with preference in the process, reference is made to the preceding description and also to the aforementioned preferred embodiments, especially as detailed in the claims.

It is made clear that the process steps of the process according to the invention as set out above are not subject to any fixed sequence in time. For example, process step c) can be executed at an early stage, at the same time as process step a).

It is a preferred embodiment of the present invention when, in process step b), the aqueous polymer dispersion is foamed by the application of high shear forces. The foaming can be effected here with the aid of shear units familiar to the person skilled in the art, for example Dispermats, dissolvers, Hansa mixers or Oakes mixers.

In addition, it is preferable when the wet foam produced at the end of process step c) has a viscosity of at least 5, preferably of at least 10, more preferably of at least 15 and even more preferably of at least 20 Pa s, but of not more than 500 Pa s, preferably of not more than 300 Pa-s, more preferably of not more than 200 Pa s and even more preferably of not more than 100 Pa-s. The viscosity of the foam can be determined here, for example, with the aid of a Brookfield viscometer, LVTD model, equipped with an LV-4 spindle. Corresponding test methods for determination of the wet foam viscosity are known to those skilled in the art.

In a preferred embodiment of the present invention, in process step b), the foam has maximum homogeneity and cell fineness. The person skilled in the art is able to verify this if desired on the basis of their typical experience in a customary manner by simple direct visual inspection by the naked eye or with optical aids, for example magnifying glasses or microscopes. “Cell fineness” relates to cell size. The smaller the average cell size, the finer the foam. If desired, the fine cell content can be determined, for example, with a light microscope or with a scanning electron microscope. “Homogeneous” means cell size distribution. A homogeneous foam has a very narrow cell size distribution, such that all cells are roughly the same size. This could be quantified in turn with a light microscope or with a scanning electron microscope.

As already described above, additional thickeners can be added to the system to adjust the wet foam viscosity. Thickeners which can be used advantageously in the context of the invention are selected here from the class of the associative thickeners. Associative thickeners here are substances which lead to a thickening effect through association at the surfaces of the particles present in the polymer dispersions. The term is known to those skilled in the art. Preferred associative thickeners are selected here from polyurethane thickeners, hydrophobically modified polyacrylate thickeners, hydrophobically modified polyether thickeners and hydrophobically modified cellulose ethers. Very particular preference is given to polyurethane thickeners. In addition, it is preferable in the context of the present invention when the concentration of the thickeners based on the overall composition of the dispersion is in the range of 0.01-10% by weight, more preferably in the range of 0.05-5% by weight, most preferably in the range of 0.1-3% by weight.

In the context of the present invention, it is additionally preferable when, in process step d), coatings of the foamed polymer dispersion with a layer thickness of 10-10 000 μm, preferably of 50-5000 μm, more preferably of 75-3000 μm, even more preferably of 100-2500 μm, are produced. Coatings of the foamed polymer dispersion can be produced by methods familiar to the person skilled in the art, for example knife coating. It is possible here to use either direct or indirect coating processes (called transfer coating).

It is also preferable in the context of the present invention when, in process step e), the drying of the foamed and coated polymer dispersion is effected at elevated temperatures. Preference is given here in accordance with the invention to drying temperatures of min. 50° C., preferably of 60° C., more preferably of at least 70° C. In addition, it is possible to dry the foamed and coated polymer dispersions in multiple stages at different temperatures, in order to avoid the occurrence of drying defects. Corresponding drying techniques taking account of temperature, ventilation and relative humidity of the atmosphere are widespread in industry and known to the person skilled in the art.

As already described, process steps c)-e) can be effected with the aid of widely practised methods known to those skilled in the art. An overview of these is given, for example, in “Coated and laminated Textiles” (Walter Fung, CR-Press, 2002).

In the context of the present invention, preference is given especially to those porous polymer coatings comprising the surfactant formulations according to the invention and having an average cell size less than 350 μm, preferably less than 200 μm, especially preferably less than 150 μm, most preferably less than 100 μm. The average cell size can preferably be determined by microscopy, preferably by electron microscopy. For this purpose, a cross section of the porous polymer coating is viewed by means of a microscope with sufficient magnification and the size of at least 25 cells is ascertained. In order to obtain sufficient statistics for this evaluation method, the magnification of the microscope chosen should preferably be such that at least 10×10 cells are present in the observation field. The average cell size is then calculated as the arithmetic average of the cells or cell sizes viewed. This determination of cell size by means of microscopy is familiar to those skilled in the art.

The porous polymer layers (or polymer coatings) according to the invention, comprising at least one of the surfactant formulations according to the invention and optionally further additives, may be used, for example, in the textile industry, for example for imitation leather materials, in the building and construction industry, in the electronics industry, in the sports industry or in the automobile industry. For instance, on the basis of the porous polymer coatings according to the invention, it is possible to produce everyday articles such as shoes, insoles, bags, suitcases, small cases, clothing, automobile parts, preferably seat covers, coverings of door parts, dashboard parts, steering wheels and/or handles, and gearshift gaiters, fitout articles such as desk pads, cushions or seating furniture, gap fillers in electronic devices, cushioning and damping materials in medical applications, or adhesive tapes.

### EXAMPLES

Substances:
SYNTEGRA® YS:3000: MDI (methyl diphenyl diisocyanate)-based polyurethane dispersion from DOW. As a result of the process for preparing it, the product contains 1-3% by weight of the anionic cosurfactant sodium dodecylbenzenesulfonate (CAS: 25155-30-0).
IMPRANIL® DLU: aliphatic polycarbonate ester-polyether-polyurethane dispersion from Covestro
REGEL® WX 151: aqueous polyurethane dispersion from Cromogenia
CROMELASTIC® PC 287 PRG: aqueous polyurethane dispersion from Cromogenia
STOKAL® STA: ammonium stearate (about 30% in H₂O) from Bozetto
STOKAL® SR: tallow fat-based sodium sulfosuccinamate (about 35% in H₂O) from Bozetto
Sodium dodecylbenzenesulfonate (LAS; CAS: 25155-30-0) was sourced from Sigma Aldrich. This is a standard cosurfactant used for production of aqueous polyurethane dispersions.
ECO Pigment Black: aqueous pigment dispersion (black) from Cromogenia.
TEGOWET® 250: polyethersiloxane-based levelling additive from Evonik Industries AG.
ORTEGOL® PV 301: polyurethane-based associative thickener from Evonik Industries AG.
REGEL® TH 27: isocyanate-based levelling additive from Cromogenia
Polyglycerol-3 stearate: Prepared by reaction of 103.3 g of polyglycerol—OHN=1124 mg
KOH/g, Mw=240 g/mol—with 155.0 g of technical grade stearic acid.
Stearyl citrate: Foaming aid, prepared by the reaction of stearyl alcohol (≥95%, 275.2 g, 1.02 mol, 2.1 eq.) with citric acid (anhydrous, 93.10 g, 0.485 mol, 1.0 eq.).
Stearyl phosphate: Foaming aid, prepared by the reaction of stearyl alcohol (≥95%, 178.7 g, 0,661 mol) with P₄O₁₀ (21.31 g, 0.0751 mol).

Viscosity Measurements:

All viscosity measurements were conducted with a Brookfield viscometer, LVTD, equipped with an LV-4 spindle, at a constant rotation speed of 12 rpm. For the viscosity measurements, the samples were transferred into a 100 ml jar into which the measurement spindle was immersed to a defined depth. The display of a constant viscometer measurement was always awaited.

### Example 1: Blending of Surfactant Formulations According to the Invention

For foaming experiments, the surfactant formulations described in Table 1 were used. All surfactant formulations were homogenized at 80° C. The surfactant formulations comprising stearyl phosphate and stearyl citrate (1, 2, 4 and 5) were neutralized to pH=7 with KOH after blending. Surfactant formulations 1-3 are inventive formulations comprising a long-chain alcohol, whereas surfactant formulations 4-6 were used for comparative purposes.

TABLE 1
Composition of surfactant blends used hereinafter:

| | Surfactant | | Surfactant | | Surfactant | | Surfactant | | Surfactant | | Surfactant | |
|---|---|---|---|---|---|---|---|---|---|---|---|---|
| | 1 | | 2 | | 3 | | 4 | | 5 | | 6 | |
| Stearyl | 20.0 | g | | | — | | 24.0 | g | — | | — | |
| phosphate | | | | | | | | | | | | |
| Stearyl | — | | 20.0 | g | — | | — | | 24.0 | g | — | |
| citrate | | | | | | | | | | | | |
| Polyglycerol- | — | | — | | 18.33 | g | — | | — | | 22.0 | g |
| 3 stearate | | | | | | | | | | | | |
| Cetearyl | — | | — | | 1.66 | g | — | | — | | 2 | g |
| sulfate | | | | | | | | | | | | |
| Stearyl | 4 | g | 4 | g | 4 | g | — | | — | | — | |
| alcohol | | | | | | | | | | | | |
| Water | 76.0 | g | 76.0 | g | 76.0 | g | 76.0 | g | 76.0 | g | 76.0 | g |

### Example 2: Foaming Tests

To test the efficacy of the additive combination according to the invention, a series of foaming experiments was conducted. For this purpose, in a first step, the IMPRANIL® DLU polyurethane dispersion from Covestro was used. The foam stabilizers used were the inventive surfactant formulations 1-3 (see table 1) and a combination of the two surfactants Stokal STA (ammonium stearate) and Stokal SR (sodium sulfosuccinamate) as comparison. Table 2 gives an overview of the compositions of the respective experiments.

All foaming experiments were conducted manually. For this purpose, polyurethane dispersion and surfactant were first placed in a 500 ml plastic cup and homogenized with a dissolver equipped with a disperser disc (diameter=6 cm) at 1000 rpm for 3 min. For foaming of the mixtures, the shear rate was then increased to 2000 rpm, ensuring that the dissolver disc was always immersed into the dispersion to a sufficient degree that a proper vortex formed. At this speed, the mixtures were foamed to a volume of about 425 ml. The mixture was then sheared at 1000 rpm for a further 15 minutes. In this step, the dissolver disc was immersed sufficiently deeply into the mixtures that no further air was introduced into the system, but the complete volume was still in motion.

TABLE 2
Overview of foam formulations:

| | #1 | #2 | #3 | #4 |
|---|---|---|---|---|
| IMPRANIL ® DLU | 150 g | 150 g | 150 g | 150 g |
| Surfactant 1 | 4 g | — | — | — |
| Surfactant 2 | — | 4 g | — | — |
| Surfactant 3 | — | | 4 g | |
| Stokal STA | — | — | | 2 g |
| Stokal SR | — | — | | 2 g |
| Wet foam viscosity [mPa s] | 7100 | 7400 | 7900 | 4000 |

In all cases, fine homogeneous foams were obtained at the end of this foaming operation. It was noticeable that the foams which had been produced with inventive surfactants 1 and 2 had a higher viscosity (see Table 2). The foams were coated onto a siliconized polyester film with the aid of a film applicator (AB3220 from TQC) equipped with an applicator frame (coat thickness=800 μm) and then dried at 60° C. for 5 min and at 120° C. for a further 5 min.

Compared to sample #4, the dried inventive samples #1-#3 featured a more homogeneous macroscopic appearance and a more velvety feel. In electron microscopy studies, moreover, it was possible to ascertain a finer pore structure.

### Example 3: Improved Cosurfactant Compatibility

To test the cosurfactant compatibility of the surfactant formulations according to the invention, a further series of foaming experiments was conducted. For this purpose, in a first step, the SYNTEGRA® YS:3000 polyurethane dispersion was used. This contains 1-3% by weight of the anionic cosurfactant sodium dodecylbenzenesulfonate (CAS: 25155-30-0). The surfactants used in these experiments were the surfactant formulations 1 and 2, and 4 and 5, listed in Table 1. Table 3 gives an overview of the composition of the foam formulations.

TABLE 3
Overview of foam formulations:

| | #5 | #6 | #7 | #8 |
|---|---|---|---|---|
| SYNTEGRA ® YS 3000 | 150 g | 150 g | 150 g | 150 g |
| Surfactant 1 | 4 g | — | — | — |
| Surfactant 2 | | 4 g | — | — |
| Surfactant 4 | — | | 4 g | — |
| Surfactant 5 | — | — | — | 4 g |

On the basis of these formulations, foam coatings were produced by the method described in Example 2. It was noticeable here that samples #7 and #8 produced with comparative surfactants 4 and 5 had a much coarser and less homogeneous foam structure. After the foam coating had dried, it was also possible to observe clear cracks in the foam structure, which is a pointer to inadequate stabilization of the foam. Samples #5 and #6 produced with the inventive surfactant formulations, by contrast, again showed an extremely fine-cell and homogeneous foam structure. They were also free of drying cracks.

In addition, a further series of foaming experiments was conducted, in which the actually cosurfactant-free IMPRANIL® DLU system was deliberately additized with sodium dodecylbenzenesulfonate, a common cosurfactant for PUD stabilization as already described.

Also used in these experiments were the surfactant formulations 1 and 2, and 4 and 5, listed in Table 1. Table 4 gives an overview of the composition of the foam formulations.

TABLE 4
Overview of foam formulations:

| | #9 | #10 | #11 | #12 |
|---|---|---|---|---|
| IMPRANIL ® DLU | 150 g | 150 g | 150 g | 150 g |
| Sodium | 1.5 g | 1.5 g | 1.5 g | 1.5 g |
| dodecylbenzenesulfonate | | | | |
| Surfactant 1 | 4 g | — | — | — |
| Surfactant 2 | | 4 g | — | — |
| Surfactant 4 | — | — | 4 g | — |
| Surfactant 5 | — | — | — | 4 g |

Here too, foam coatings were produced by the method described above. It was again noticeable here that the samples #11 and #12 produced with comparative surfactants 4 and 5 had drying cracks and a much coarser cell structure, whereas the inventive samples #9 and #10 again showed a fine and homogeneous cell structure and were free of defects. Virtually no difference from the analogous, cosurfactant-free samples #1 and #2 (see Example 2) was observable here. These experiments thus demonstrate the distinct improvement in cosurfactant compatibility of the surfactant formulations according to the invention.

### Example 4: Migration Tests

To assess the surface migration of the surfactants according to the invention, imitation leather materials were produced by the method that follows. First of all, a topcoat coating was applied to a siliconized polyester film (layer thickness 100 μm). This was then dried at 100° C. for 3 minutes. Subsequently, a foam layer was coated onto the dried topcoat layer (layer thickness 800 μm) and dried at 60° C. for 5 minutes and at 120° C. for 5 minutes. In a last step, an aqueous adhesive layer (layer thickness 100 μm) was coated onto the dried foam layer, and then a textile carrier was laminated onto the still-moist adhesive layer. The finished laminate was dried again at 120° C. for 5 minutes and then detached from the polyester film.

All coating and drying operations were performed here with a Labcoater LIFE-S from Mathis AG. Topcoat and adhesive layer were formulated here in accordance with the compositions listed in Table 5; the foam layers used were the foam formulations listed in Table 2, which were foamed by the method described in Example 2.

For assessment of surfactant migration, the imitation leather samples, after production, were placed into water at 100° C. for 30 minutes and then dried at room temperature overnight. After this treatment, the comparative sample produced from the Stokal STA/SR surfactants (foam formulation #4, Table 2) had distinctly visible white spots on the surface of the imitation leather, whereas this surface discoloration was not observed in the case of the samples produced with the surfactants according to the invention (foam formulation #1, #2 and #3, Table 2).

TABLE 5
Topcoat and adhesive formulation for production
of imitation leather materials:

| | Topcoat | Adhesive |
|---|---|---|
| CROMELASTIC ® PC 287 | 100 g | — |
| PRG | | |
| REGEL ® WX 151 | — | 100 g |
| ECO Pigment Black | 10 g | 5 g |
| TEGOWET ® 250 | 0.2 g | 0.2 g |
| REGEL ® TH 27 | 6 g | 6 g |
| ORTEGOL ® PV 301 | 7 g | 5 g |

### Example 5: Improved Foaming Rate

The foaming rate was assessed by conducting a last series of foaming experiments with Impranil DLU, a PU dispersion. For this purpose, the two surfactant mixtures 3 and 6 (Table 1) were used. Table 6 gives an overview of the composition of the foam formulations.

TABLE 6
Overview of foam formulations:

| | #13 | #14 |
|---|---|---|
| IMPRANIL ® DLU | 150 g | 150 g |
| Surfactant 3 | 4 g | — |
| Surfactant 6 | — | 4 g |
| Time until a foam volume | 2 min 20 sec | 5 min 35 sec |
| of 425 ml was attained | | |

The foam formulations were foamed by the method described in Example 2, but with the difference that the foaming operation was conducted at a reduced speed of 1200 rpm. It was observed here that the foam formulation containing the inventive surfactant blend 3 (experiment #13) attained the target volume of 425 ml much more quickly than the comparative sample #14 comprising the inventive surfactant 6. In both cases, fine-cell foams were obtained at the end of the foaming operation. These were coated onto a release paper in a last step after the method described in Example 2, and dried. In both cases, it was possible here to obtain homogeneous foam coatings that had no drying defects at all after drying. The reduced foaming time achieved by means of the surfactant blend according to the invention consequently had no adverse effect at all on the quality of the foam obtained.

1-13. (canceled)

14: A process for producing a porous polymer coating, the process comprising:
a) providing a mixture comprising at least one aqueous polymer dispersion, a surfactant formulation comprising at least one interface-active foam stabilizer and at least one long-chain alcohol, and optionally, at least one further formulation component,
b) foaming the mixture to give a wet foam,
c) optionally, adding at least one thickener to adjust the viscosity of the wet foam,
d) applying a coating of the wet foam to a suitable carrier, and
e) drying the coating.

15: The process according to claim 14, wherein the at least one long-chain alcohol comprises an alcohol with the general formula (I)
R¹—OH Formula (I),
wherein R¹ is a monovalent aliphatic or aromatic, saturated or unsaturated, linear or branched hydrocarbyl radical having 12 to 40 carbon atoms.

16: The process according to claim 14, wherein the at least one long-chain alcohol is selected from the group consisting of lauryl alcohol (1-dodecanol), myristyl alcohol (1-tetradecanol), cetyl alcohol (1-hexadecanol), margaryl alcohol (1-heptadecanol), stearyl alcohol (1-octadecanol), arachidyl alcohol (1-eicosanol), behenyl alcohol (1-docosanol), lignoceryl alcohol (1-tetracosanol), ceryl alcohol (1-hexacosanol), montanyl alcohol (1-octacosanol), melissyl alcohol (1-triacontanol), palmitoleyl alcohol (cis-9-hexadecen-1-ol), oleyl alcohol (cis-9-octadecen-1-ol), elaidyl alcohol (trans-9-octadecen-1-ol), respective structural isomers of the same empirical formulae, and mixtures of these substances.

17: The process according to claim 14, wherein the at least one long-chain alcohol is selected from the group consisting of cetyl alcohol, stearyl alcohol, behenyl alcohol, and mixtures of these substances.

18: The process according to claim 14, wherein the at least one long-chain alcohol is a branched primary or secondary alcohol.

19: The process according to claim 14, wherein the at least one long-chain alcohol is a Guerbet alcohol or a branched secondary alcohol formed by paraffin oxidation by the Bashkirov method.

20: The process according to claim 14, wherein the at least one interface-active foam stabilizer and the at least one long-chain alcohol are pre-formulated.

21: The process according to claim 14, wherein the at least one interface-active foam stabilizer is selected from the group consisting of amphoteric surfactants and betaines, amidopropyl betaines, amphoacetates, anionic surfactants, alkyl or alkylaryl sulfosuccinates, sulfosuccinamates, sulfates, sulfonates, phosphates, citrates, carboxylic salts, nonionic surfactants, polyol ethers, polyol esters, and mixtures of these substances.

22: The process according to claim 14, wherein the at least one interface-active foam stabilizer is selected from the group consisting of polyol ethers, polyol esters, alkyl phosphates, alkyl citrates, and mixtures of these substances.

23: The process according to claim 14, wherein the at least one interface-active foam stabilizer is an alkyl phosphate, an alkyl citrate, or a mixture thereof.

24: The process according to claim 23, wherein the alkyl phosphate is a phosphoric ester of a long-chain alcohol having at least 12 carbon atoms; and wherein the alkyl citrate is a citric ester of a long-chain alcohol having at least 12 carbon atoms.

25: The process according to claim 23, wherein the alkyl phosphate is a phosphoric ester of a long-chain alcohol having a degree of esterification in the range of 1-2.5; and wherein the alkyl citrate is a citric ester of a long-chain alcohol having a degree of esterification in the range of 1-2.6.

26: The process according to claim 14, wherein the surfactant formulation comprises at least one further surfactant.

27: The process according to claim 26, wherein the at least one further surfactant is selected from the group consisting of fatty acid amides, ethylene oxide-propylene oxide block copolymers, amine oxides, quaternary ammonium surfactants, amphoacetates, ammonium and/or alkali metal salts of fatty acids, silicone-based surfactants, trisiloxane surfactants, polyethersiloxanes, and mixtures of these substances.

28: The process according to claim 14, wherein the at least one aqueous polymer dispersion is selected from the group consisting of polystyrene dispersions, polybutadiene dispersions, poly(meth)acrylate dispersions, polyvinyl ester dispersions, and polyurethane dispersions, and
wherein a solids content of the at least one aqueous polymer dispersion is in the range of 20-70% by weight, based on an overall dispersion.

29: The process according to claim 14, wherein the at least one aqueous polymer dispersion is a polyurethane dispersion.

30: The process according to claim 29, wherein a solids content of the at least one aqueous polymer dispersion is in the range of 20-70% by weight, based on an overall dispersion.

31: The process according to claim 14, wherein a total concentration of the at least one interface-active foam stabilizer and the at least one long-chain alcohol in the mixture is in the range of 0.2-20% by weight.

32: A porous polymer coating, produced from the process according to claim 14.
